(19) United States
(12) Patent Application Publication
(10) Pub. No.: US 2002/0055899 A1
(43) Pub. Date: May 9, 2002

(54) Display system and method for displaying and organizing financial information

(76) Inventor: Joseph C. Williams, Cincinnati, OH (US)

Correspondence Address: Mark D. Elchuk, Harness Dickey & Pierce P.L.C., P.O. Box 828, Bloomfield Hills, MI, 48303, US

(21) Appl. No.: 09/731,267

(22) Filed: Dec. 6, 2000

Related U.S. Application Data
(60) Provisional application No. 60/169,233, filed on Dec. 6, 1999.

(51) Int. Cl. G06F 17/60

(52) U.S. Cl. 705/37

(57) ABSTRACT

A system and method for displaying and organizing highly complex and voluminous financial information pertaining to stock market trading activity on a computer display terminal in a manner that permits an individual to easily monitor and assimilate the information. The system forms a visual display which organizes and presents the trading information for a selected stock in a number of independent regions on a computer display terminal. A user can choose to display information pertaining to a number of user-defined stocks from a plurality of tabs along an upper edge of the display. For any stock selected, ask and bid sales and volume information for all of the auction participants for the selected stock can be displayed along with post trade information. Other significant information pertaining the trading positions of the auction participants is readily discernable from changes in color of the tabs designating those auction participants. Still other regions of the display allow the user to replay all previous activity information for the selected stock or to view pertinent post-trade analytical information concerning the stock. The system and method enable non-professional individuals to more easily discern trends in the activity of those stocks important to the user as well as to more quickly discern important trends in the trading activities of the auction participants for each of those stocks.

### TECHNICAL FIELD

This invention relates to software systems for displaying large amounts of data in various forms on a display terminal to improve the ease with which the information may be viewed, and more particularly to a software system for presenting a large amount of financial data, in real time, on a computer display terminal in a logically organized manner to aid a user in evaluating and assimilating the financial information much more easily and quickly than with prior information presentation systems.

### BACKGROUND OF THE INVENTION

At the present time there is an unprecedented level of interest and personal involvement by individuals in the stock market. As a result of individual retirement accounts (IRAs), 401 K plans, etc. and, most importantly, access to on-line trading of securities, more and more people are actively following and participating in stock market trading. Over the next several years, market hours are expected to be extended for many of the existing stock exchanges, and the number of on-line accounts is expected to increase significantly. On-line trading has also made it possible for individuals to execute trades from their homes or offices without the involvement of a broker.

With more and more individuals actively participating in on-line trading, there is an increased need to provide highly complex and voluminous financial information, which has heretofore not been readily available to professionals, and non-professional individuals in a manner which enables the information to be quickly and easily understood. As an example, information has long been available from a NASDAQ “Level 2” data feed to professionals such as stock brokers and professional traders. However, such information is not readily understood and/or assimilated quickly by most individuals who are not highly experienced in the securities markets. For the non-professional, and the inexperienced professional, it would take considerable time and experience to gain sufficient familiarity with the information presented in a Level 2 data feed before this information could become a valuable tool to the individual.

Even when complex financial information is available, such as with the Level 2 data feed described above, the data is not presented in a logically organized manner so as to provide a complete analysis of the information and/or to readily indicate trends or trading patterns of market participants. Thus, certain valuable information is virtually ignored even when such information could be extrapolated from the raw financial data being provided by the data feed.

It is therefore a principal object of the present invention to provide a system and method for storing information on a file server and organizing and presenting a large volume of highly complex information on a visual display terminal used with a computer system in such a manner as to enable non-professional financial persons, and professionals alike, to much more easily assimilate the information to help such individuals to make better educated trading decisions when participating in stock market trading.

More specifically, it is an object of the present invention to provide a system and method for logically organizing and providing a visual representation of a large volume of highly complex data in such a manner that a non-professional individual, or even a professional financial person, can easily monitor information pertaining to any one of a large plurality of stocks or other securities such as, but not limited to, bonds, options and derivatives, and can further select to display, in greater detail, specific sub-groups of valuable information extrapolated from the raw data received from a data feed that pertain to the activity of that particular selected stock or security.

It is still another object of the present invention to provide a system and method which is capable of presenting a large amount of useful financial data in real time, and which also provides the ability for the user to quickly review past market activity over a variable period ranging from one minute to one month or longer, to thus gain a greater appreciation as to the trends of those stocks important to the individual.

It is still another object of the invention to provide high performance data management by using a server computer or computers to provide data storage and data calculations. This allows efficient use of the user's computer by sending only the required data to their system.

It is still another object to provide a system and method which presents a large amount of financial information in a form which is much easier for the individual to assimilate, and which further permits the user to sort pre-trade and post-trade financial information in numerous ways to further enhance the usefulness of the information.

It is yet another object of the present invention to provide a system and method for organizing and displaying pre-trade and post-trade information for virtually any number of user designated stocks or other forms of securities such as mentioned above, and which makes use of color, and changes in color saturation, to indicate trading activity of the auction participants of any stock being monitored by the user.

### SUMMARY OF THE INVENTION

The above and other objects are provided by a system and method in accordance with preferred embodiments of the present invention. In one preferred embodiment, the system of the present invention comprises a software system for displaying and organizing complex and voluminous Level 1 and Level 2 stock market data in a manner which makes the data much more easily assimilated by the user. The system allows the user to define virtually any number of particular stocks which the user wishes to monitor. These user-designated stocks are then represented along one edge of a computer display terminal in a first region with a “tab” associated for each stock. The user can select any particular stock by positioning the pointer of a graphical user interface, such as a mouse, over the tab representing the desired stock, and clicking on the tab. This presents a variety of information pertaining to that particular selected stock. Controls are also provided to enable the user to quickly scroll through the tabs, via a mouse, to select a desired stock.

Each tab further includes a visual indicator which is illuminated whenever a user defined event occurs relative to that stock. This allows the user to be immediately apprised that the event has occurred, even if the user is not viewing that stock.

Whenever a stock is selected, a second region of information is visible to the user. This information includes, but is not limited to, displays of the trading volume for that stock on the particular day on which the information is viewed, the current bid price for the stock, the current asking price for the stock, the opening price, the price of the position the user is holding and the long and short positions of the user. It may also display the user's current loss or gain on both an active and a simulated account, along with the user's stop position.

A third region of the system may be included to display a digital clock. The clock can be set for any time zone and has a user defined display to alert the user of important events before same occur, such as the closing of the NASDAQ within a certain number of minutes, a closing of the bond market within a selected number of minutes, or any other or even non-market related event having relevance to the user.

A fourth region may be included to display the last minutes of trading activity of the stock currently selected by the user, in graphical format, from the time and sales ticker information from the data feed. This feature also allows the user to customize the display to include the previous days, weeks, months or year's activity of the selected stock such that this information appears at the beginning of each day. This enables the user to recognize more quickly trend patterns of given stocks.

A fifth region of information of the display includes volume and price information for each sale flowing directly from the activity of each auction participant for the selected stock.

A sixth region of the display provides a wide variety of information, some of which has heretofore been completely unavailable, pertaining to the activities of all of the auction participants regarding the particular selected stock. It further presents the information in a unique manner making same much more easily visually assimilated by the individual, and further in a manner which assists the individual in recognizing trading patterns or trends of the auction participants. In one preferred embodiment the present invention displays the bid and ask data of each auction participant in an associated column. This important information is presented in one region of the display with the above-mentioned columns arranged side-by-side. In this manner the user can quickly ascertain important “bid” and “ask” information for a number of auction participants at a glance.

A pair of seventh regions of the display system form “rulers” which display the price on both of the “ask” and “bid” sides of the selected stock in user defined increments. The scale for viewing this information is set automatically by the system based upon the selected stock's price and volatility. This region is also customizable by the user for each stock selected.

An eighth region of the display system graphically displays the trading volume for the stock presently being viewed by the user.

A ninth region contains tabs for overlaying technical analysis graphs while the area below the ninth region of the display system forms a “trader player” which for the first time ever allows the user to stop, start, “rewind” and “replay” previous activity for the selected stock. The playback speed is also adjustable by the user.

A tenth region of the display system displays the time for the historic activity being displayed below in region nine. If the trader player is not in use, then the simulation clock displays the current time of day. If the trader player below region nine is in use, then the simulation clock of region ten shows the actual time pertaining to the data being displayed by the trader player.

An eleventh region of the display system forms a transparent overlay which displays one or more market analysis studies selected by the user that pertain to the stock being viewed. The technical analysis studies may also be defined by the user.

A twelfth region of the display system forms a transparent overlay which uses horizontal bars to display the trading volume at each price point of the stock being viewed or the incidences of auction participants at each price.

A thirteenth region of the display system is used to graphically display the theoretically worse case scenario for exiting a stock based upon the presumption that all trading for that particular stock has ceased and all orders were executed matching the current bid price and volume to the current ask price and volume.

It will be appreciated that the display system of the present invention preferably displays several of the above-described regions in overlapping fashion with other ones of the regions. Thus, any selected region can be brought to the front of the display system such as, for example, by positioning the pointer of a mouse over the desired region and clicking on the mouse. It is also a principal advantage of the display system that region six, which displays all of the auction participant's activity relative to the currently selected stock, is placed on one side of the display system, and therefore represents pre-sales activity, while other information representing post-sales activity is presented adjacently thereto on the other side of the display system with information flowing from one side of the display directly to the other on a single chart.

Various ones of the above-described regions also make use of colors, and more particularly changes in color, to quickly indicate to the user significant activity occurring relative to a particular stock. All colors can be specified by the user. In this manner, the user can be alerted to important activity concerning any one or more of a large plurality of stocks that the user is tracking activity for. The alerts can be customized by the user for each stock they follow. For example, an alert may be set to notify the user if a stock goes outside its 52 week average. All calculations for the alert are done on the server and only the alert notification is sent to the user. When significant activity is noted, the user can then select that particular stock to present a full array of financial data and market activity pertaining to that particular stock.

While the present application makes specific reference throughout to stocks, it will be appreciated that the invention can be adapted to use with little or no modification to monitor other forms of securities such as bonds, options and derivatives.

### BRIEF DESCRIPTION OF THE DRAWINGS

The various advantages of the present invention will become apparent to one skilled in the art by reading the following specification and subjoined claims and by referencing the following drawings in which:

FIG. 1 is a simplified view illustrating the various regions of the display system and method of the present invention;

FIG. 2 is a view of the auction participant activity region illustrating pertinent pre-trade information on the activities of each auction participant for the selected stock or other form of security;

FIG. 3 is an enlarged view of the field pertaining to one of the auction participants shown in FIG. 2;

FIG. 4 is a view of a pop-up screen displayable by the user for any auction participant;

FIG. 5 is a view of information displayed in the sales ticker region R5;

FIG. 6 is a view of the information presented in the auction participant region (R6) together with the information presented in the sales and ticker region (R6);

FIG. 7 is a display of the one minute bar graph information of region R4; and

FIG. 8 is a view of the clocks of regions R3 and R10, together with the scales used in regions R7₁ and R7₂, and also the various sort buttons.

### DETAILED DESCRIPTION OF THE PREFERRED EMBODIMENTS

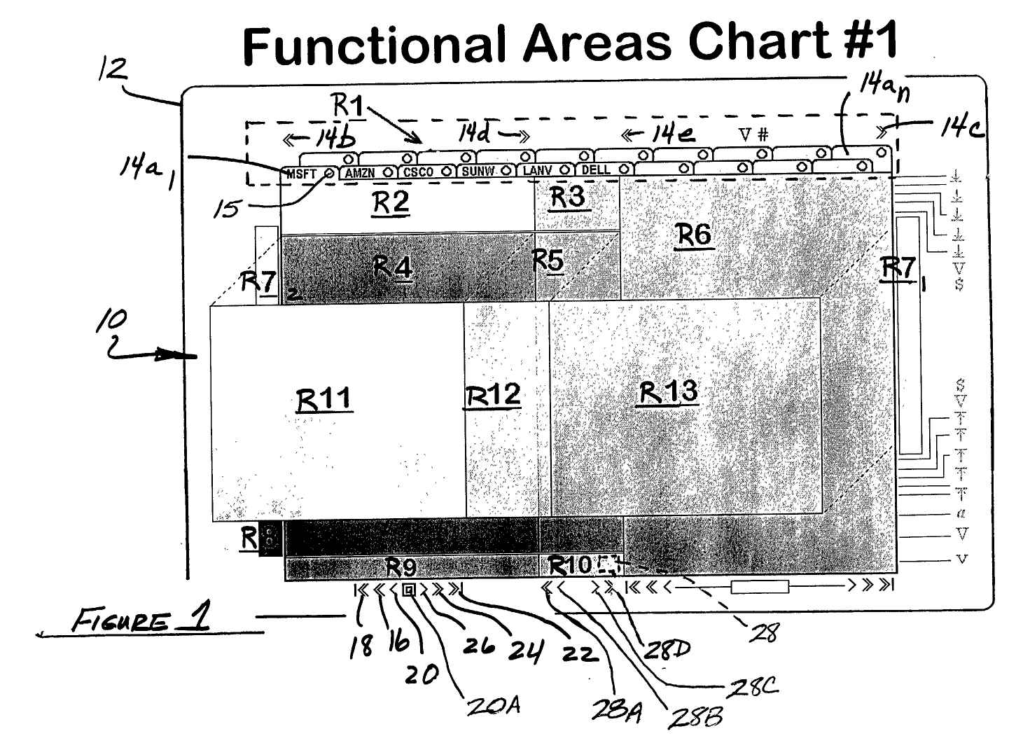

Referring to FIG. 1, there is shown a display system 10 in accordance with one preferred form of the present invention. The display system 10 comprises a means for logically organizing and visually presenting a large amount of financial and stock market information in a much more easily assimilated form, thus enabling nonprofessional as well as professional individuals alike to more readily assimilate a large volume of information concerning any number of user selected stocks, bonds, derivatives, options, or virtually any other form of security. It will further be appreciated that the information, which is stored on a file server, and which is organized and presented in a highly efficient manner by the system and method of the present invention, is extrapolated from a suitable data feed, such as a NASDAQ Level 1 data feed or a NASDAQ Level 2 data feed, which feeds raw financial information into the file server. The manner in which this data is organized and displayed by the system and method of the present invention, as will be explained in greater detail in the following paragraphs, allows the information to be accessed and assimilated much more efficiently by the user, thus enabling the user to make better informed decisions when participating in stock market trading activities. The display system 10 is written in Java, but it will be appreciated that the system 10 could be constructed in a number of different programming languages including, but not limited to, C++.

The display system 10 shown in FIG. 1 is displayed on a display terminal 12, which is in turn coupled to a suitable computer system. The computer system (not shown) is in turn in communication with the file server which collects, calculates and stores the data from the data feed supplying the information that appears on the display terminal 12. Preferably, the computer system incorporates a mouse or other suitable graphical user interface which permits the user to select various portions of the information displayed on the display terminal 12 simply by, for example, positioning a pointer or cursor over the desired area and clicking with a mouse. It will be appreciated that such control could also be implemented from a keyboard of the computer system but it is expected that a mouse will be the preferred means for most users in using the display system 10.

The display system 10 sorts and organizes the voluminous amount of data received from the data feed into a plurality of regions. Each region may be “selected” by simply positioning the mouse pointer over the desired region and clicking with the mouse or entering a keyboard command. For the purpose of description, further reference to selecting any one of the regions to be described below will be explained in connection with the use of a mouse. At any time a user may right click the mouse on any control element, such as a button or tab, in the system 10 and the system 10 will display the function that each element performs.

The display system 10 includes a first region R1, preferably disposed along the upper edge of the screen of the display system 12, which contains a plurality of “tabs” 14a₁-14aₙ which each designate a particular stock within a group of stocks that the user has chosen to monitor. It will be appreciated that a virtually infinite number of stocks can be selected by the user to represent various stocks which the user wishes to track. In the present example, the stocks of Microsoft, Inc.7 (MSFT), Amazon.com7 (AMZN), Cisco Systems, Inc.,7 (CSCO), Sun Microsystems, Inc.7 (SUNW), Lanvision Systems, Inc.7 (LANV) and Dell, Inc.7 (DELL) are shown for illustrative purposes only.

The user configures a tab 14a for a particular stock by selecting a “new” tab and inputting the four letter stock market abbreviation code for that particular company. By selecting arrow 14c, the user can increase the number of auction participants in the display by 5. By selecting arrow 14e the number of auction participants in the display is reduced by 5. The use of arrow 14d reduces the size of the minute bar graph by one-half an hour while 14b increases the size of the minute bar graph by one-half an hour up to 6.5 hours. The stocks are also sorted in alphabetical order such that those designated stocks behind the particular company selected are displayed in alphabetical order from left to right. The “V” button allows the user to display the volume at each price point for the horizontal bars in overlay area 12. The designator “#” allows the user to display the number of occurrences for the horizontal bars in overlay area 12.

With further reference to FIG. 1, when tab 14a (MSFT) is selected, then this tab is brought to the front of region “R1” and all of the pertinent financial information pertaining to Microsoft's7 stock is displayed in every information region of display system 10. Selecting tab 14a containing CSCO would similarly cause its stock to be brought to the front and all of the stock market activity pertaining to CSCO would be displayed.

Each tab 14a further includes an indicator 15 which provides a visual indication to the user that a user-defined event has occurred. The user defined event may be, for example, that stock going outside of its 52 week moving average. This feature will be described in detail in the following paragraphs.

Referring further to FIG. 1, region “R2” comprises a “summary block”. The summary block is used for presenting a numerical summary of the data presented graphically on other portions of the display system 10 for the particular stock being viewed. This may include, but is not limited to, a display of the day's trading volume for the selected stock, the current bid price, current ask price, the opening price, the price of the position the user is presently holding, as well as the user's long and short positions. It also displays the current loss or gain on the user's active account, as well as on a simulated account (if same is being used), along with the user's “stop” position for the selected stock.

Region “R3” displays a digital clock that can be set for any time zone. It also has a user defined display to alert the user of important events such as the closing of a particular stock exchange within a particular number of minutes. Accordingly, the user, for example, could configure the clock to sound an alarm over a speaker associated with the computer system or provide a visual indication within region R3 that the NASDAQ will be closing within ten minutes, that the bond market will be closing within 15 minutes, or the time for opening rush, final sprint, morning reversals, lunch break, Cinderella hour, or any other relevant, time-sensitive information important to the user.

Region “R4” displays the last minutes trades for up to 6.5 hours in graphical format flowing directly from the sales ticker, which will be described momentarily. Region R4 also allows the user to customize the display to include the previous days, weeks, months or even year's activity of the selected stock at the beginning of each day so that trend patterns for that particular stock may be recognized more quickly and easily.

Region “R5” is used to denote price and volume activity flowing directly from the activities of the auction participants for the selected stock.

Region “R6” illustrates the activities of all of the auction participants for the stock being viewed and presents the information in a unique manner which serves to make the information much more quickly and easily assimilated by the user. This region will be discussed in detail in the following paragraphs.

Regions “R7₁” and “R7₂” each represent a “ruler” which is used to display the price and volume on both the ask and bid side for the selected stock in user defined dollar increments. The system 10 automatically sets the scale appearing within each region R7₁ and R7₂ for each particular stock viewed based upon that stock's price and volatility. For example, for a stock with high volatility, the system 10 displays the price in smaller increments, such as down to 32nds of a dollar or 64ths of a dollar, whereas other stocks may be displayed down to eighths or sixteenths of a dollar. However, the user can customize this region for each stock denoted by tabs 14a₁14aₙ. The increments can also be defined by the user to allow the data displayed in region R7₁ and R7₂ to be presented in decimal notation. This is defined under a preferences menu to be explained momentarily.

Region “R8” graphically displays the trading volume for the selected stock being viewed.

The “buttons” below “R9” include the “Trader Player” control bar, which allows the user to stop, start, rewind and replay historical data at various speeds. Button 20A allows the user to stop and start the screen activity. Selecting arrow 28B rewinds the activity 15 minutes each time it is clicked via the mouse. Selecting arrow 28A rewinds the activity 1 hour for each mouse click. Arrow 28C moves forward 15 minutes for each mouse click. Arrow 28D moves forward one hour for each time it is clicked via the mouse. Selecting arrow 18 takes the user back to the beginning of the day's trading activity. Selecting arrow 22 takes the user to the present activity, or to the end of the day of if the trading day is over. Selecting arrow 20 slows down the speed of the replay slightly, while arrow 16 slows down the replay considerably. Selecting arrow 26 speeds up the replay slightly, while arrow 24 speeds up the playback considerably.

Region “R10” is used to display a “simulation” clock which displays the time associated with the information being viewed on the trader player display at region R9. If the trader player of region R9 is not in use, then the simulation clock displays the current time of day. If the trader player is in use it will show the time it is actually running the trading data for. It also includes a bar, represented by dashed line 28, moving from left to right in the drawing of FIG. 1, which represents the difference between the current time and the time running on the trader player of region R9. As the bar 28 moves to the right, the difference between the time displayed on the digital clock in region R3 (i.e., the actual time of day) and the time displayed in region R10 will be reduced. When both clocks display the same time, then the user will know that the information being displayed in the trader player region R9 is real time information.

Region “R11” represents a “technical trading and trading studies overlay” region for displaying graphs of a plurality of different studies used for market analysis and technical trading. The particular studies displayed are selectable by the user. The tabs for the technical trading overlays are located in Region “9”. This region also overlays the price paid, stop order and sell point as set by the user.

Referring to region “R12”, this region forms a transparent overlay that makes use of horizontal bars to display the trading volume at each price point for the selected stock, or the number of instances of auction participants at each price point.

Region “R13” graphically displays the theoretically worse case scenario for exiting a stock based upon the presumption that all trading ceased and all orders were executed matching the current bid price and volume to the current ask price and volume.

It will be appreciated that each of the regions 1-10 may be displayed or not displayed based upon user preference. Regions 11-13 are transparent overlays which can be brought to the front of the display by positioning the mouse pointer over the visible portion of that particular region and clicking with the mouse.

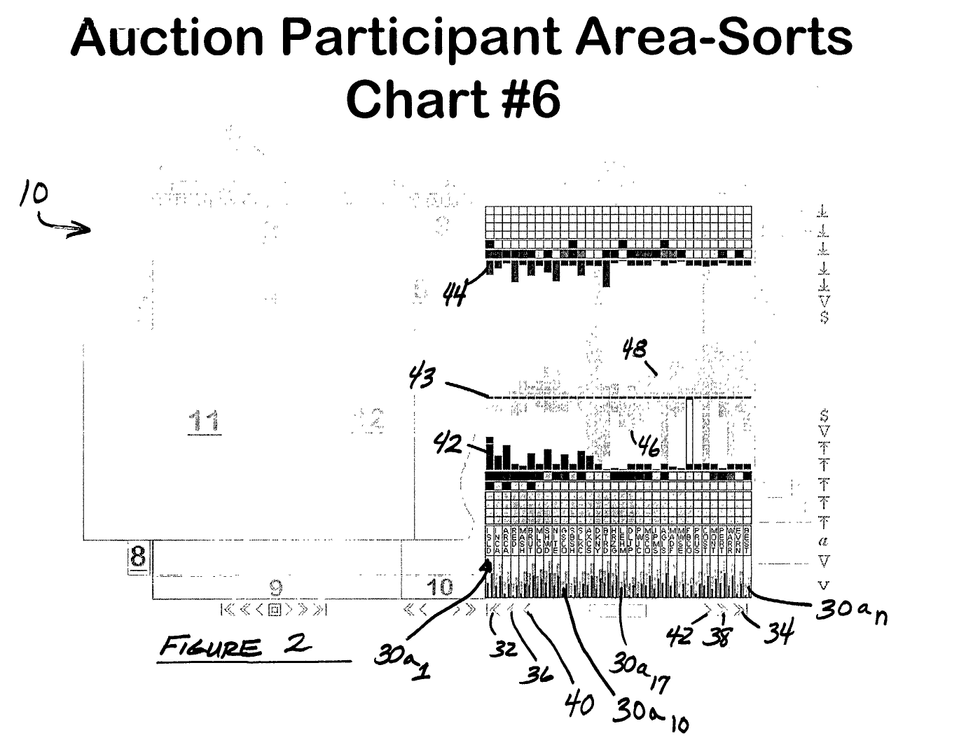

Referring now to FIG. 2, the wide ranging auction information available for viewing in region R6 can be seen in greater detail. The auction chart is basically comprised of a number of fields 30a₁-30aₙ. Each field 30a includes information pertaining to the market activity of each auction participant involved with the selected stock being viewed. As will be understood by those involved in the financial markets, the auction participants are those organizations such as brokerage firms and electronic communications networks (ECNs) actively engaged in buying and selling securities. For example, “LEHM” at field 30a₁₇ designates the Lehman Brothers Brokerage Firm where as “ISDL” represents the Island ECN.

Arrow 32 underneath region R6 allows the user to jump to the first (i.e., leftmost) auction participant while arrow 34 allows the user to jump to the last (i.e., rightmost) auction participant. Arrows 36 and 38 allow the user to scroll quickly in either the left or right directions in increments of 5 to display a particular desired auction participant. Arrows 40 and 42 allow the user to scroll one field at a time through the various listed auction participants in either direction.

Running horizontally through the auction region R6 is the “inside market” line 43. The inside market line 43 represents the price between the current best bid and the current best ask price. Each field 30a₁-30aₙ includes blocks 42 indicating the volume of the selected stock that that particular auction participant is willing to purchase. Similarly, block 44 in each field 30a represents that volume of stock that each particular auction participant is willing to sell. Also associated with each field 30a is a vertical bar 46 which extends downwardly from the inside market line indicating the present bid price for that particular stock at the volume represented in bar 42 for each auction participant. Above the inside market line, each field 30a includes a vertical bar 48 representing the present ask price by each auction participant for the selected stock at the volume represented in bar 44. The actual price increments for the selected stock are displayed vertically in region R7₁ on one side of the screen of the display terminal 12 and in R7₂ on the opposite side of the screen, while the volume is displayed in region “R8” below region R7₂.

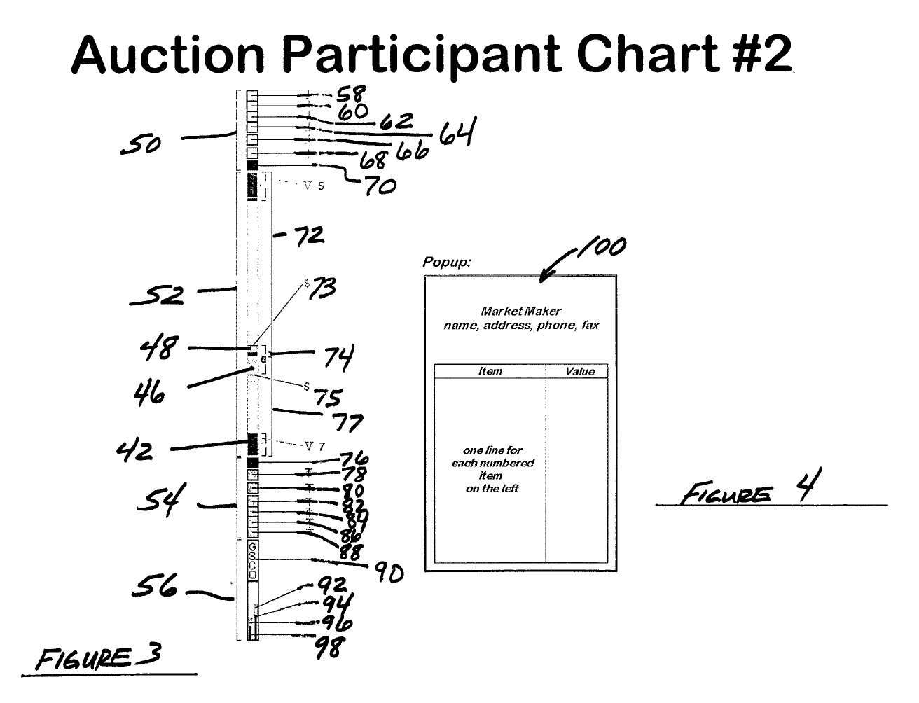

Referring now to FIG. 3, a more detailed analysis of the auction and ticker region R6 will be provided with reference to one particular auction participant. In this instance the auction participant is Goldman Sachs Co. (which also appears in field 30a₁₀ in FIG. 2 as GSCO). Each field 30a is comprised of a plurality of smaller sub-fields graphically representing various information on the activity of the auction participant. Sub-field 50 represents the “ask volatility” area, which displays the primary ask activities of each auction participant. Sub-field 52 represents an auction participant histogram for graphically displaying the price and volume for both the bid and ask for the selected stock by the auction participant. Sub-field 54 represents the “bid volatility” area which displays the primary bid activities of each auction participant. Sub-field 56 contains the auction participant's identification and volume history.

With specific reference to sub-fields 50 and 54, a plurality of indicator cells or blocks 58-70 and 76-88 are shown. It should also be noted that each indicator display may be turned on or off based upon user defined parameters. Block 58 represents the “inside market switch indicator.” This block 58 displays a color when an auction participant moves away from the inside market line 43 on FIG. 1 by raising their ask price. The color display increases in intensity each time another move away from inside market is made. Accordingly, the user is quickly apprised whenever a particular auction participant begins making a series of movements away from the inside market price. The color fades over time if no moves are made indicating that the information is getting stale.

Block 60 displays a color when the auction participant moves toward the inside market line 43 on FIG. 2 by lowering their ask price. The color increases in intensity each time another move toward inside market is made. The color fades over time if no moves are made, indicating that the information is getting stale.

Block 62 displays a color when the auction participant refreshes their ask. This means that their previous ask was accepted, and they have renewed their offer to sell. As this number of times increases, the color becomes more saturated, thus providing a quick visual indication to the user of this activity. This color intensity also fades over time if no activity of the auction participant occurs. Block 64 makes use of color intensity to indicate the number of times the auction participant has been at inside market that day. The greater the number of times, then the more saturated the color becomes, again providing a quick visual indication to the user. The color will fade over time if no activity occurs. Block 66 displays a color when an auction participant switches from inside market on one side of the inside market line 43 to the other side. The color display increases in intensity each time another inside market switch is made by the auction participant. Again, however, the color fades over time if no activity of the auction participant occurs.

Sub-field 68 is an inside market indicator which is illuminated when the auction participant is at inside market and is off when the auction participant is not. Sub-field 70 represents a “movement” indicator which uses color intensity to indicate when an auction participant has changed its bid or ask price. If the auction participant raises its ask or raises its bid, then a designated color will appear, such as blue, to indicate that the activity may drive the price of the stock upwards. The more times the auction participant raises their bid or ask, the more intense the color becomes. If the participant lowers its bid or ask, then a different color will be displayed in a sub-field 70, such as brown, to indicate that the activity may drive the price downward. The more times the participant lowers its bid or ask, the more intense the color will become. The intensity of the colors in sub-fields 68 and 70 diminishes over time if no further activity occurs, thus indicating that the activity is becoming stale and therefore less valid.

For the user to set the specific price or volume limits described above, the user left clicks with the mouse pointer positioned in the pertinent region. This brings up a “pop-up” menu which displays all the options that the user may desire to set. Data input is accomplished using standard languages and prompts supported by Microsoft7. User definitions can be set for individual stocks, groups of stocks or all stocks or securities in their portfolio. For example, left clicking on region R2 would bring up a pop-up menu specific to Region R2. In region R2 the user can also select preferences for other information such as numerical displays of the current day's trading volume, current bid price, current ask price, and the opening price of a selected stock for that particular day. The user may also specify the price position they are holding for a selected stock, their long and short position and the color for the various indicators employed to visually signal important activity of the auction participants.

Referring further to FIG. 3, area 72 represents the “ask” area for displaying the ask volume and ask price. Line 73 represents the auction participant ask price. Area 74 is the “inside market spread indicator”, which displays the best bid and ask of all auction participants. Line 75 represents the auction participant bid price. Sub-field 46 corresponds to the bid price while sub-field 48 corresponds to the ask price. Area 77 is the “bid” area for displaying the bid volume and bid price. The bid volume, represented by block 42 on FIG. 2 represents the volume of shares the auction participant is willing to purchase.

With further reference to FIG. 3, area 54 further includes a number of sub-fields 76-88 which correspond identically in function to sub-fields 58-70 described previously herein. The only difference being that sub-fields 76-88 are used to signify auction participant bid activity rather than ask activity. Sub-field 90 includes the identification designation for the auction participant, in this example “GSCO” for Goldman Sachs Co.

With further reference to FIG. 3, several bar graphs 92-98 are used to graphically present important information concerning the trading volume of the stock for a particular auction participant. Graph 92 indicates the year-to-date total volume of the stock traded by the displayed auction participant. Graph 94 indicates the year to date block trade volume of the auction participant. A block trade is defined as a trade of over 10,000 shares. Graph 96 indicates the total volume of the previous month of the displayed auction participant in the selected stock, and graph 98 illustrates the previous month's block trade volume by the auction participant in the selected stock.

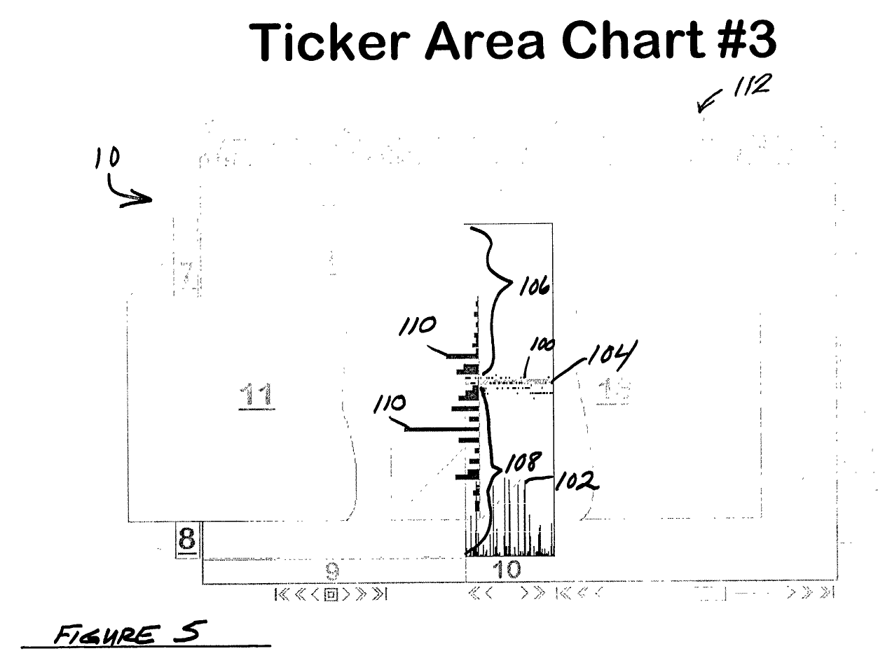

With brief reference to FIG. 4, the user can position the pointer of the mouse over any of the blocks making up any of the fields 30a, by right clicking on the mouse, and an informational “pop-up” 100 will be displayed. The pop-up provides specific information for the selected auction participant as well as numerical information corresponding to the various sub-fields described in FIG. 3.

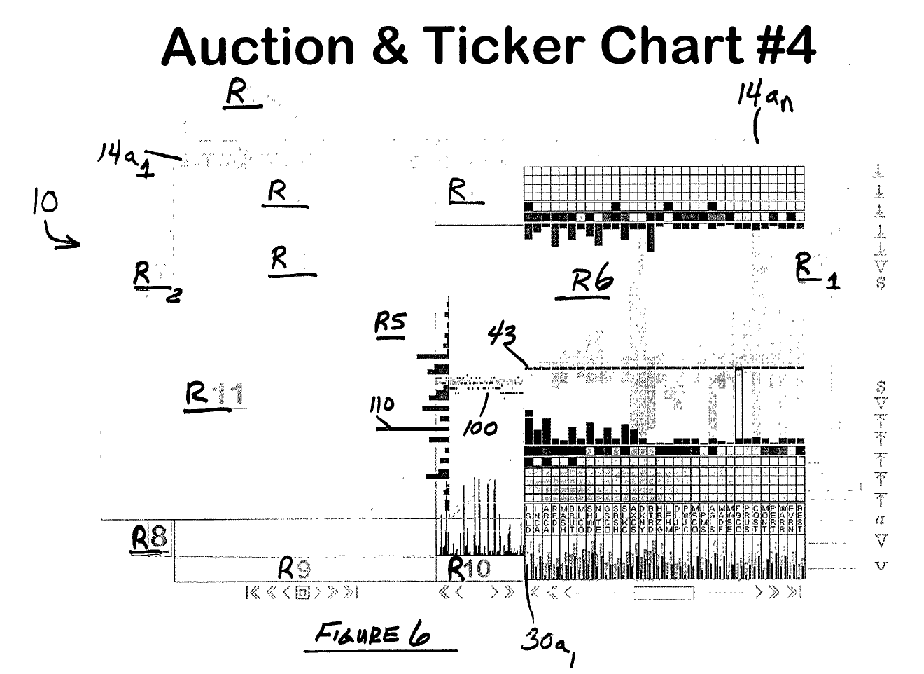

Referring now to FIG. 5, the sales ticker information of region R5 is displayed in greater detail. Small black squares, such as square 100, each represent a particular transaction (i.e., trade) concerning the selected stock. The vertical bar graph which is vertically in line with each square, such as bar graph 102 which is vertically aligned with square 100, graphically indicates the volume of that particular trade. The sales ticker region R5 also includes scales on both sides of an inside market line 104 for indicating price, although this scale has been omitted for purposes of clarity in the drawing of FIG. 5. The sales ticker includes regions 106 and 108 within which horizontal bar graphs 110 may be displayed. The bar graphs appearing in area 106 graphically represent the volume of shares at each ask price. Graphs 110 in area 108 similarly represent the volume of shares available at each bid price. By clicking on element 112 (“#”), the graph changes colors and displays the number of instances at each price. Clicking on the “V” button with the mouse changes the display back to volume. It will also be appreciated that the squares representing transactions will be continually moving from right to left as new ticker information arrives from the data feed, flowing directly from the auction participant area.

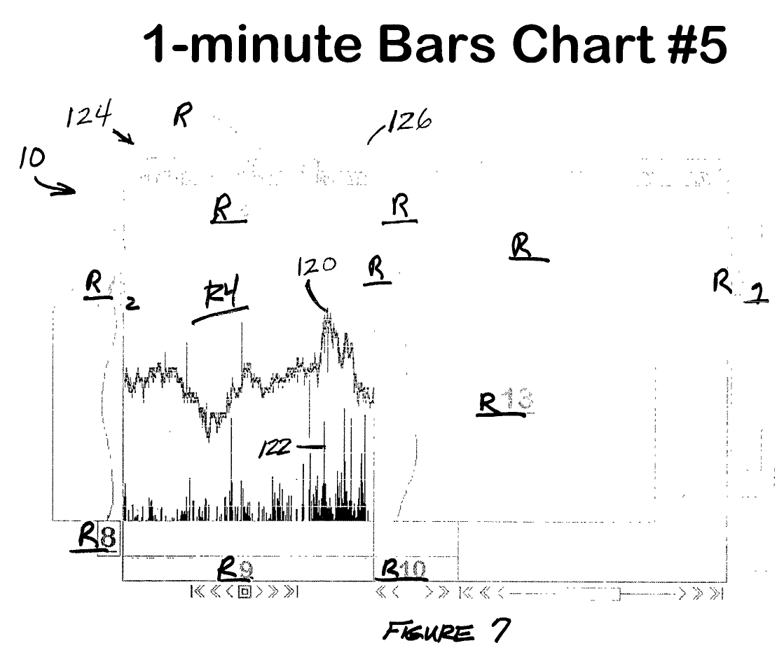

Referring briefly to FIG. 6, the sales ticker information is shown together with the auction participant information. This provides a valuable, quick visual reference to the user both in terms of pre-trade and post-trade information.

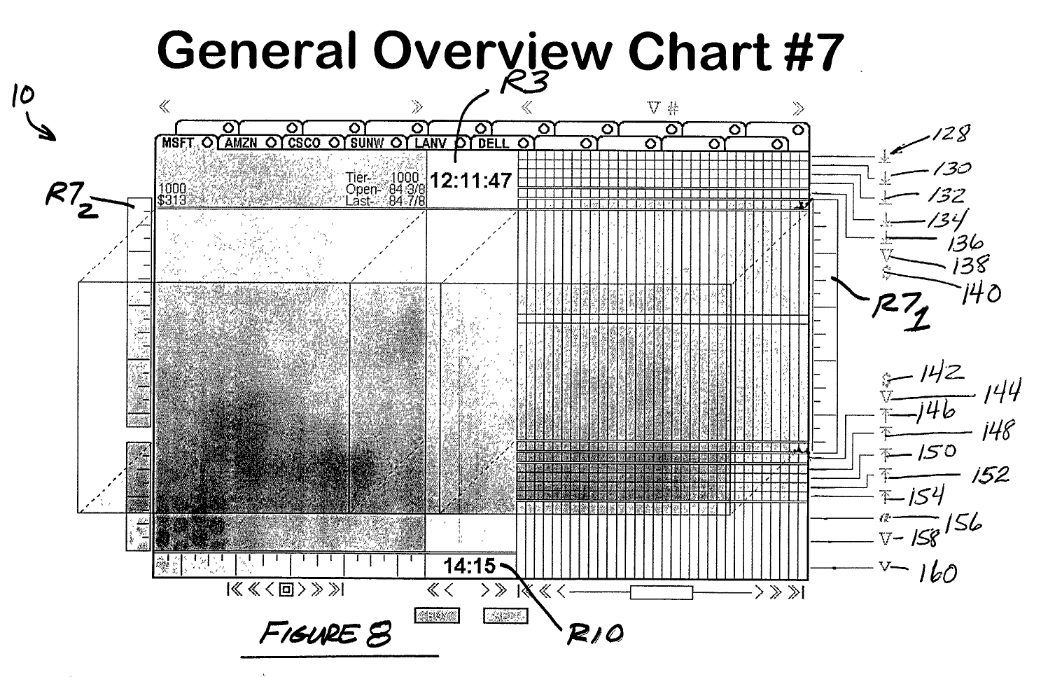

Referring now to FIG. 7, the one minute bar chart of region R4 is displayed. As can be seen, the dark black dots 120 represent actual trades, with the rightmost side of region R4 representing the most recent trades having occurred. Bar graphs 122 along the lower edge of region R4 represent the total volume of each particular trade. The light grey graph immediately above each black dot represents the highest trade price at that particular minute that the trade occurred. The bar graph 122 extending directly below each dot 120 indicates the lowest price at that particular minute for the selected stock. Selecting button 124 increases the minute bar graph by one-half an hour up to 6.5 hours. Selecting button 126 decreases the minute bar graph by one-half an hour.

Referring now to FIG. 8, the clocks appearing in regions R3 and R10, as well as simplified representations of the scales used in regions R7₁ and R7₂, are visible. It also displays the “sort” buttons.

Selecting sort button 128 sorts on the number of times an auction participant has moved away from inside market. The auction participant with the most such moves will be on the left, and the auction participant with the least such moves will be on the right.

Selecting sort button 130 sorts on the number of times the auction participant has moved toward inside market. The auction participant with the most such moves will be on the left, and the auction participant with the least such moves will be on the right.

Selecting sort button 132 sorts on the number of times an auction participant has refreshed. The auction participant with the most number of refreshes will be on the left, and the auction participant with the least number of refreshes will be on the right.

Selecting sort button 134 sorts on the number of times the auction participant has been at inside market. The auction participant with the greatest number of instances will be on the left, and the auction participant with the least on the right.

Selecting sort button 136 sorts on all the auction participants who are at inside market. Therefore, those with their inside market indicator on will be to the left.

Selecting sort button 138 “V” sorts all auction participants based on their ask volume. The auction participant with the highest such volume will be on the left, and the auction participant with the least on the right.

Selecting sort button 140 “$” sorts on all auction participants based on their ask price. The auction participant with the highest ask price will be on the left, and the auction participant with the lowest will be on the right.

Sort buttons 142, 144, 146, 148, 150, 152 and 154 represent the same sort activity as buttons 128-140, respectively, except on the “bid” side activity rather than the “ask” side activity.

Selecting sort button 156 (“a”) sorts on all auction participants in alphabetical order, from left to right.

Selecting sort button 158 (“V”) sorts the auction participants on their year-to-date total volume. The auction participant with the highest such volume will be on the left, and the auction participant with the least on the right.

Selecting sort button 160 (“v”) sorts the auction participants on the previous month's volume. The auction participant with the highest such volume will be on the left, and the auction participant with the least on the right.

The system and method 10 of the present invention thus provides a means to monitor a very large amount of complex stock, bond, option, derivative or virtually any other securities related information on a variety of exchanges, and in a manner which makes same much more easily assimilated by non-professionals and professionals alike. The system 10 of the present invention presents the information received from a data feed in a manner which also makes important trends, which would be important in making a trading decision, quickly discernable by even non-professionals. The system and method 10 further enables an extremely large volume of trading activity to be reviewed quickly to further help identify important trading trends concerning those stocks which the user is monitoring. The particular manner in which the present invention logically organizes the large amount of data and presents same in easy to discern graphical formats further significantly eases the manner in which the information may be assimilated by individuals and used to make more intelligent stock trades.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and following claims.

What is claimed is:

1. A software system for organizing and monitoring a large amount of financial information pertaining to trading activities occurring on a financial market exchange, and presenting such information on a video display screen, comprising:
a header display region for displaying a header corresponding to at least one user defined company which a user desires to monitor financial information pertaining thereto; and
an auction participant region for displaying said financial information in real time in an easily viewable graphical format, said financial information relating to trading activities concerning said one user defined company by a plurality of user designated auction participants.

2. The system of claim 1, wherein said financial information includes real time information presented in a graphical format on a current ask price, a current bid price, a current volume of shares available at said ask price, and a current volume of shares sought at said bid price, for each of said user selected auction participants.

3. The system of claim 2, wherein said auction participant region includes an inside market line designation for denoting a midpoint between highest one of said bid prices and a lowest one of said ask prices for said auction participants defined by said user.

4. The system of claim 1, further comprising a summary region capable of being displayed on said display concurrently with said header display region, for displaying a summary of financial information of the user selected company.

5. The system of claim 1, further comprising a recent trades region capable of being displayed on said display concurrently with said header display region, for displaying information concerning recently executed trades of financial instruments of said user selected company.

6. The system of claim 2, further comprising at least one display region arranged as a narrow elongated display for displaying in real time price and volume information on at least one of said ask and bid prices for financial instruments of the user selected company.

7. The system of claim 1, further comprising a price and volume activity region for displaying, in real time, price and volume information flowing directly from trading activities of all of the user designated auction participants, relative to the user selected company.

8. The system of claim 1, further comprising an historical trading playback function and a user operated control panel for enabling a user to replay on the video display screen previously stored portions of auction participant activity which has occurred over a user defined time period, concerning a financial instrument of the user selected company.

9. The system of claim 8, wherein the user can fast forward said previously stored portions of said financial information on said video display screen via said control panel.

10. The system of claim 1, further comprising a technical studies overlay display region for displaying market analysis graphs on a portion of said video display concerning the user selected stock.

11. The system of claim 1, further comprising at least one sort control for enabling said user to sort market activity of said auction participants on said video display into a predetermined pattern on said video display in accordance with a predetermined criterion.

12. A software system for organizing and monitoring a large amount of financial information pertaining to financial instrument trading activities concerning a plurality of companies occurring on a financial exchange, and presenting such information on a video display screen in an easily to view graphical format, the system comprising:
a header display region for displaying headers corresponding to a plurality of user defined companies which a user desires to monitor financial information pertaining thereto, said headers being selectable by said user to allow said user to monitor and review detailed information concerning financial instrument trading activities for the selected said company; and
a replay system including user actuatable controls for enabling said user to selectively re-display archived portions of said financial information on said video display.

13. The system of claim 12, further comprising an auction participant display region for displaying real time information in a graphical format concerning bid prices and ask prices relating to said financial instruments, and volume information for each of said bid and ask prices, of a plurality of user designated auction participants engaged in financial instrument trading activities concerning said user selected company.

14. The system of claim 13, wherein said ask and bid prices and said volume information of each of said user selected auction participants is presented in an elongated subregion adjacent one another for quick visual comparison.

15. The system of claim 13, wherein said auction participant display region includes an inside market line designation for denoting a midpoint between a highest one of said bid prices and a lowest one of said ask prices for said auction participants defined by said user.

16. The system of claim 12, further comprising at least one sort control for enabling said user to sort market activity of said auction participants on said video display into a predetermined pattern on said video display in accordance with a predetermined criterion.

17. The system of claim 12, wherein said auction participant region includes indicator cells assigned to each said auction participant which change color to denote trends in trading activities of each of said auction participants.

18. The system of claim 12, further comprising a summary region capable of being displayed on said display concurrently with said header display region, for displaying a summary of said financial information pertaining to one of said user selected companies.

19. The system of claim 12, further comprising a price and volume activity region for displaying, in real time, price and volume information flowing directly from trading activities of all of the user designated auction participants, relative to the user selected company.

20. The system of claim 12, further comprising further comprising a technical studies overlay display region for displaying market analysis graphs concerning the user selected financial instrument.

21. A software system for organizing and monitoring a large amount of financial information pertaining to financial instrument trading activities concerning a plurality of companies occurring on a financial exchange, and presenting such information on a video display screen in an easily viewable and comprehendible graphical format lending itself to quick visual interpretation by a user, said system comprising:
a header display region for displaying headers corresponding to a plurality of user defined companies which a user desires to monitor financial information pertaining thereto, said headers being selectable by said user to allow said user to monitor and review detailed information concerning financial instrument trading activities for the selected said company;
an auction participant display region for displaying real time financial information concerning bid prices and ask prices, and volume information for each of said bid and ask prices, in an easy to interpret graphical format, of a plurality of user designated auction participants engaged in financial instrument trading activities concerning said user selected company; and
a sort control for allowing said user to said auction participants to organized and presented on said video display screen in accordance with a plurality of user defined criteria.

22. The system of claim 21, further comprising a replay control displayed on said video display for allowing a user to replay archived portions of said financial information of selected ones of said user defined companies on said video display.

23. The system of claim 22, wherein said auction participant region includes a plurality of indicator cells associated with each of said auction participants; and
wherein said cells change color in response to activity of each of said auction participants.
